(19) United States
(12) Patent Application Publication
(10) Pub. No.: US 2019/0387410 A1
(43) Pub. Date: Dec. 19, 2019

(54) SENSOR INTERFERENCE MITIGATION USING GEO-LOCATION BASED TRANSMISSION RESOURCE ALLOCATION FOR VEHICLE SENSORS

(71) Applicant: GM GLOBAL TECHNOLOGY OPERATIONS LLC, Detroit, MI (US)

(72) Inventors: Oded Bialer, Petah Tivak (IL); Tal Philosof, Givatayim (IL)

(21) Appl. No.: 16/007,300

(22) Filed: Jun. 13, 2018

(51) Int. Cl. H04W 16/02; H04W 72/04; H04W 4/40

(52) U.S. Cl. CPC H04W 16/02; H04W 4/40; H04W 72/04

(57) ABSTRACT

Embodiments include methods, systems and computer readable storage medium for geo-location based transmission resource allocation for vehicle sensors. The method includes determining available transmission resources for an area and partitioning the area into a plurality of cells. The method includes determining whether the plurality of cells exceeds the available transmission resources and allocating a portion of the available resources to a first set of one or more cells. The method includes reusing the portion of the available resources allocated to the first set of one or more cells by allocating the portion of the available resources to a second set of one or more cells and assigning transmission resources associated with the second set of one or more cells to a second set of one or more vehicles when the second set of one or more vehicles enters an area associated with the second set of one or more cells.

### INTRODUCTION

The subject disclosure relates to rideshare services, and more specifically to mitigating sensor interference between vehicles.

Autonomous vehicles are automobiles that have the ability to operate and navigate without human input. Autonomous vehicles, as well as some non-autonomous vehicles, use sensors, such as radar, LIDAR, global positioning systems, and computer vision, to detect the vehicle's surroundings. Advanced computer control systems interpret the sensory input information to identify appropriate navigation paths, as well as obstacles and relevant signage. Some autonomous vehicles update map information in real time to remain aware of the autonomous vehicle's location even if conditions change or the vehicle enters an uncharted environment. Autonomous vehicles increasingly communicate with remote computer systems and with one another using V2X communications (Vehicle-to-Everything, Vehicle-to-Vehicle, Vehicle-to-Infrastructure).

Active sensors such as, for example, radar and LIDAR are sensors that actively send/emit a wave/signal from the sensor and measure a reflection of the wave. With an increasing number of vehicles using active sensors and the vehicles operating in close proximity to each other, active sensors for one vehicle may receive signals sent from active sensors of another vehicle. The reception of foreign signals by a vehicle (i.e., interference) can lead to problems such as ghost targets (i.e., additional vehicles) or a reduced signal-to-noise ratio. Additionally, active signal emissions generated by vehicles near another vehicle can interfere with the detection of a vehicles or objects that are further away from the vehicle.

Accordingly, it is desirable to provide a system that can mitigate sensor interference in light of a limited transmission resource allocation to address such interference.

### SUMMARY

In one exemplary embodiment, a method for geo-location based transmission resource allocation for vehicle sensors is disclosed. The method includes determining, by a processor, available transmission resources for an area. The method further includes partitioning, by the processor, the area into a plurality of cells. The method further includes determining, by the processor, whether the plurality of cells exceeds the available transmission resources. The method further includes allocating, by the processor, a portion of the available resources to a first set of one or more cells. The method further includes reusing, by the processor, the portion of the available resources allocated to the first set of one or more cells by allocating the portion of the available resources to a second set of one or more cells. The method further includes assigning, by the processor, transmission resources associated with the second set of one or more cells to a second set of one or more vehicles when the second set of one or more vehicles enters an area associated with the second set of one or more cells.

In addition to one or more of the features described herein, one or more aspects of the described method can additionally assign transmission resources associated with the first set of one or more cells to a first set of one or more vehicles. Another aspect of the method is that the assigned transmission resources are utilized by one or more active sensors associated with each of the first set of one or more vehicles and each of the second set of one or more vehicles. Another aspect of the method is that reusing the portion of the available resources allocated to the first set of one or more cells is based on a predetermined threshold distance between the first set of one or more cells and the second set of one or more cells. Another aspect of the method includes using a pre-determined set of global rules to relate a geo-location for each vehicle of a first set of vehicles and the second set of vehicles to transmission resources allocated to the first set of one or more cells and second set of one or more cells. Additionally, the available resources include at least one of: time, frequency and code. Another aspect of the method can include monitoring movements associated with each of the first set of one or more vehicles and each of the second set of one or more vehicles and assigning transmission resources associated with a new cell when a vehicle enters into the new cell from a previous cell.

In another exemplary embodiment, a system for geo-location based transmission resource allocation for vehicle sensors is disclosed herein. The system includes one or more vehicles and one or more servers in which the one or more servers each comprise a memory and a processor coupled to the memory, wherein the processor is operable to determine available transmission resources for an area. The processor is further operable to partition the area into a plurality of cells. The processor is further operable to determine whether the plurality of cells exceeds the available transmission resources. The processor is further operable to allocate a portion of the available resources to a first set of one or more cells. The processor is further operable to reuse the portion of the available resources allocated to the first set of one or more cells by allocating the portion of the available resources to a second set of one or more cells. The processor is further operable to assign transmission resources associated with the second set of one or more cells to a second set of one or more vehicles when the second set of one or more vehicles enters an area associated with the second set of one or more cells.

In yet another exemplary embodiment a computer readable storage medium for geo-location based transmission resource allocation for vehicle sensors is disclosed herein. The computer readable storage medium includes determining available transmission resources for an area. The computer readable storage medium further includes partitioning the area into a plurality of cells. The computer readable storage medium further includes determining whether the plurality of cells exceeds the available transmission resources. The computer readable storage medium further includes allocating a portion of the available resources to a first set of one or more cells. The computer readable storage medium further includes reusing the portion of the available resources allocated to the first set of one or more cells by allocating the portion of the available resources to a second set of one or more cells. The computer readable storage medium further includes assigning transmission resources associated with the second set of one or more cells to a second set of one or more vehicles when the second set of one or more vehicles enters an area associated with the second set of one or more cells.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a computing environment according to one or more embodiments;

FIG. 2 is a block diagram illustrating one example of a processing system for practice of the teachings herein;

FIG. 3 depicts an interaction between a plurality of vehicles which each employ one or more active sensors according to one or more embodiments;

FIG. 4 depicts an area employing geo-location based transmission resource allocation according to one or more embodiments;

FIG. 5A depicts a flow diagram of a method for geo-location based transmission resource allocation for vehicle sensors according to one or more embodiments; and

FIG. 5B depicts a flow diagram of a method for geo-location based transmission resource allocation for vehicle sensors according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

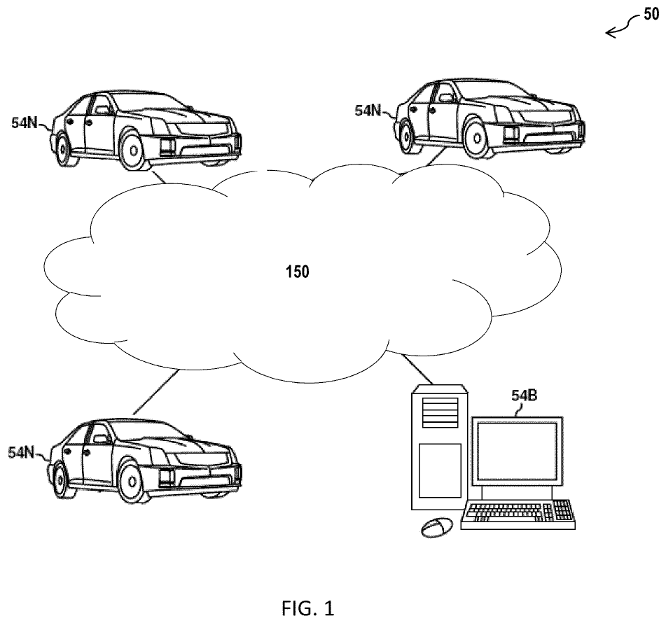

In accordance with an exemplary embodiment, FIG. 1 illustrates a computing environment 50 associated with a system for malicious basic safety message detection using an angle of arrival. As shown, computing environment 50 comprises one or more computing devices, for example, a server 54B, and/or a plurality of automobile onboard computer systems 54N, each associated with an autonomous or non-autonomous vehicle, which is connected via network 150. The one or more computing devices can communicate with one another using network 150.

Network 150 can be, for example, a cellular network, a local area network (LAN), a wide area network (WAN), such as the Internet, a dedicated short range communications network (for example, V2V communication (vehicle-to-vehicle), V2X communication (i.e., vehicle-to-everything), V2I communication (vehicle-to-infrastructure), and V2P communication (vehicle-to-pedestrian)), or any combination thereof, and may include wired, wireless, fiber optic, or any other connection. Network 150 can be any combination of connections and protocols that will support communication between server 54B, and/or the plurality of vehicle on-board computer systems 54N, respectively.

Each of the plurality of vehicle on-board computer systems 54N can include a GPS transmitter/receiver (not shown) which is operable for receiving location signals from a plurality of GPS satellites (not shown) that provide signals representative of a location for each of the mobile resources, respectively. In addition to the GPS transmitter/receiver, each vehicle associated with one of the plurality of vehicle on-board computer systems 54N may include a navigation processing system that can be arranged to communicate with a server 54B through the network 150. Accordingly, each vehicle associated with one of the plurality of vehicle on-board computer systems 54N is able to determine location information and transmit that location information to the server 54B or another vehicle on-board computer system 54N.

The vehicle on-board computer system 54N may also include one or more active and passive sensors (e.g., radar, LIDAR, cameras (internal and external), weather, longitudinal acceleration, voice recognition, or the like). The vehicle on-board computer system 54N may also include one or more microphones and a speech processing application.

Additional signals sent and received may include data, communication, and/or other propagated signals (e.g., signals associated with LIDAR and/or radar). Further, it should be noted that the functions of transmitter and receiver can be combined into a signal transceiver.

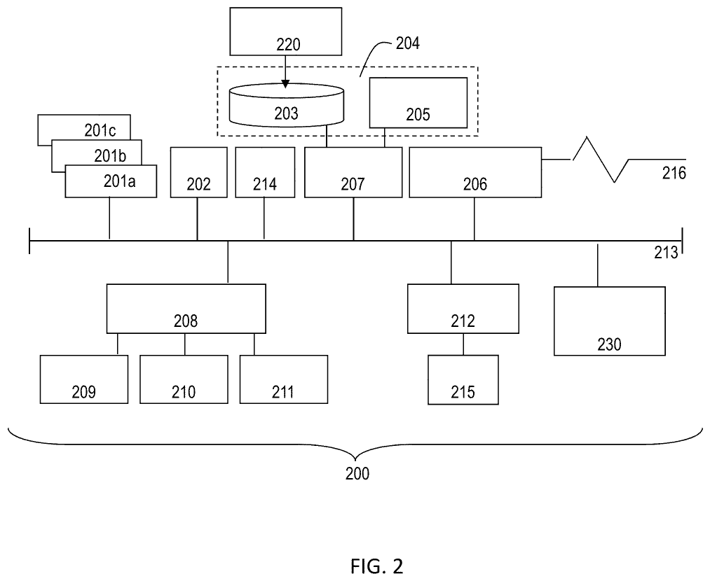

In accordance with an exemplary embodiment, FIG. 2 illustrates a processing system 200 for implementing the teachings herein. The processing system 200 can form at least a portion of the one or more computing devices, such as server 54B, and/or vehicle on-board computer system 54N. The processing system 200 may include one or more central processing units (processors) 201a, 201b, 201c, etc. (collectively or generically referred to as processor(s) 201). Processors 201 are coupled to system memory 214 and various other components via a system bus 213. Read only memory (ROM) 202 is coupled to the system bus 213 and may include a basic input/output system (BIOS), which controls certain basic functions of the processing system 200.

FIG. 2 further depicts an input/output (I/O) adapter 207 and a network adapter 206 coupled to the system bus 213. I/O adapter 207 may be a small computer system interface (SCSI) adapter that communicates with a hard disk 203 and/or other storage drive 205 or any other similar component. I/O adapter 207, hard disk 203, and other storage device 205 are collectively referred to herein as mass storage 204. Operating system 220 for execution on the processing system 200 may be stored in mass storage 204. The network adapter 206 interconnects bus 213 with an outside network 216 enabling data processing system 200 to communicate with other such systems. A screen (e.g., a display monitor) 215 can be connected to system bus 213 by display adaptor 212, which may include a graphics adapter to improve the performance of graphics intensive applications and a video controller. In one embodiment, adapters 207, 206, and 212 may be connected to one or more I/O busses that are connected to system bus 213 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 213 via user interface adapter 208 and display adapter 212. A keyboard 209, mouse 210, and speaker 211 can all be interconnected to bus 213 via user interface adapter 208, which may include, for example, a Super I/O chip integrating multiple device adapters into a single integrated circuit.

The processing system 200 may additionally include a graphics-processing unit 230. Graphics processing unit 230 is a specialized electronic circuit designed to manipulate and alter memory to accelerate the creation of images in a frame buffer intended for output to a display. In general, graphics-processing unit 230 is very efficient at manipulating computer graphics and image processing, and has a highly parallel structure that makes it more effective than general-purpose CPUs for algorithms where processing of large blocks of data is done in parallel.

Thus, as configured in FIG. 2, the processing system 200 includes processing capability in the form of processors 201, storage capability including system memory 214 and mass storage 204, input means such as keyboard 209 and mouse 210, and output capability including speaker 211 and display 215. In one embodiment, a portion of system memory 214 and mass storage 204 collectively store an operating system to coordinate the functions of the various components shown in FIG. 2.

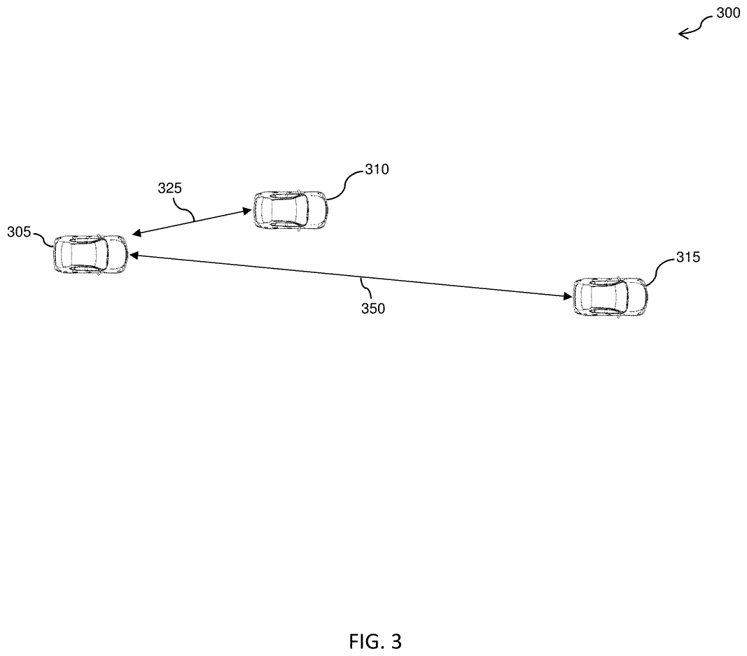

FIG. 3 depicts an interaction 300 between a plurality of vehicles 305, 310 and 315, in which each vehicle employs one or more active sensors according to one or more embodiments. Each of the vehicles, 305, 310 and 315 can include an automobile onboard computer system 54N. While traveling along a road network, each of the vehicles, 305, 310 and 315 can utilize one or more active sensors to aid in traversing the road network. Transmissions emitted by the one or more active sensors for each of the vehicles, 305, 310 and 315 can interfere with transmissions or measurements conducted by other vehicles. Transmitting vehicles (e.g., vehicle 305 and vehicle 310) which are a distance 325 (i.e., a distance which is in close proximity to one another) can result in an increased interference being observed by the vehicles which are in close proximity (near) to each other. As a longer distance 350 between transmitting vehicles (e.g., vehicle 305 and vehicle 315) occurs, the observed interference between vehicles decreases. Interference strength between vehicles in light of distance can determined using the following equation: I_{strength} varies as 1/distance².

Typical solutions to mitigate the interference between vehicles employ manipulating a combination of different transmission resources. The resources can include frequency band (frequency), transmission time slots (time) and transmission codes (code). Given the increasing number of vehicles being manufactured that utilize active sensors, using different combinations of transmission resources for assignment to each vehicle on the road network to avoid interference will soon be untenable because the number vehicles using active sensors within a given area will soon outnumber the amount of available resource combinations.

Embodiments of the present disclosure can overcome typical solutions to mitigate active sensor interference by using transmission resource allocation based on geo-location, such that vehicles that are within close proximity (near) to each other can transmit using one set transmission resources and vehicles that are not within close proximity (far) vehicles can re-use the set of transmission resources or a slight variation of the set of transmission resources while avoiding interference issues due to such reuse. Reusing transmission resources can occur because a distance at which the reuse of transmission resources occurs is of a sufficient length that interference with other locations using the same or similar transmission resources does not arise.

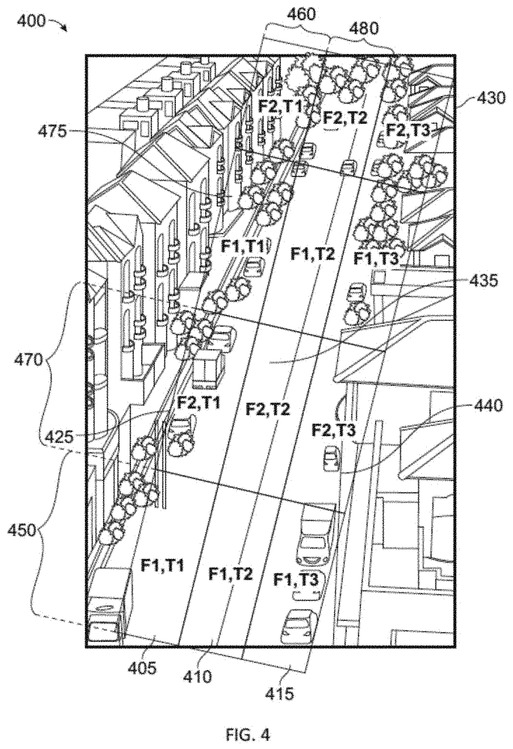

In accordance with an exemplary embodiment, FIG. 4 depicts an area 430 employing geo-location based transmission resource allocation 400 according to one or more embodiments. The area 430 can be subdivided/partitioned into a plurality of smaller areas/cells, for example, cells 405, 410, 415, 425, 435, 440 and 475. Each cell can be assigned a frequency (F) and time (T). If additional resources for a given are needed, each cell can be assigned a code or another available resource. In addition, each cell can be geo-located and a predetermined length and width can be assigned to each cell. The geo-location of the cells can based on, for example, global positioning system (GPS).

For example, cell 405 can be assigned a frequency (F1) and a time (T1), cell 410 can be assigned a frequency (F1) and a time (T2) and cell 415 can be assigned a frequency (F1) and a time (T3). A transmission area for each cell can be a predetermined length 450 and width 460. After reaching a predetermined length 450 and/or width 460 within area 430, another frequency (F2, F3, F4, etc.) and/or time (T2, T3, T4, etc.) can be assigned to another cell in area 430.

Because cells 405, 410, 415, 425, 435 and 440 have different resources allocated to each cell, interference between vehicles can be obviated or reduced because a limited number of vehicles can occupy each cell. As mentioned above, resources available for allocation to a group of cells is limited. Transmission resource allocation 400 can compensate for a limited amount of transmission resources for allocation by reusing resource combinations assigned to cells (e.g., cell 405 and cell 475). The reuse can be in consideration of a predetermined distance 470 and/or predetermined width 480 between the cells having commonly allocated transmission resources. The predetermined distance 470 and/or predetermined width 480 can be a length in consideration of the interference strength equation. For example, predetermined distance 470 can be a length in which cell 405 and cell 475 can be allocated the same transmission resources but would not interfere with each other or the interference between cell 405 and cell 475 would be negligible. Predetermined width 480 can be determined in a manner similar to predetermined distance 470.

Using transmission resource allocation 400, vehicles traveling within area 430 travel between cells can use transmission resources allocated to active sensors for a particular cell (e.g., cell 415) and subsequently switch to resources assigned to another/new cell (e.g., cell 440) upon entry into the new cell. Transmission resource allocation 400 can assign the same transmission resources to different cells within area 430 in consideration of a predetermined length and/or width. Accordingly, an increased number of vehicles can utilize active sensors within area 430 because resources within area 430 can be reused.

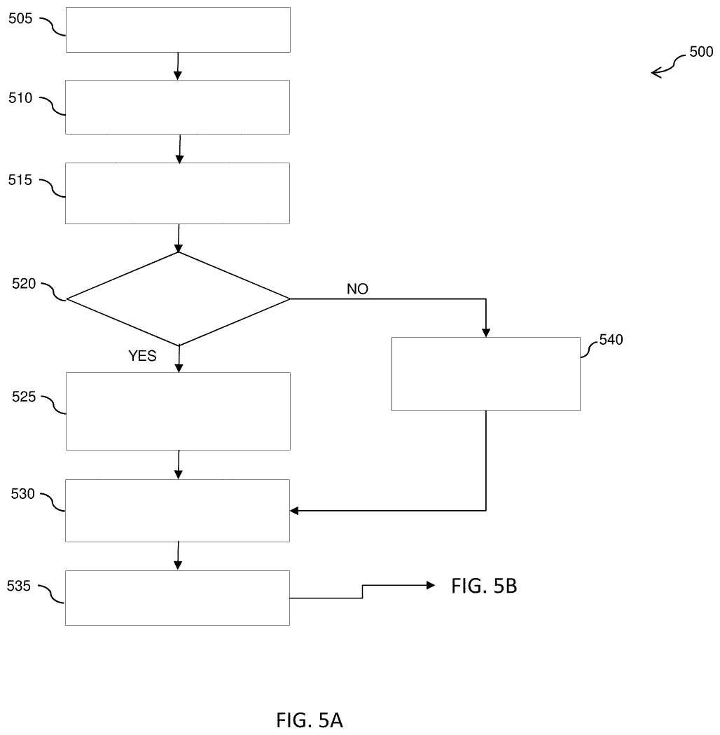

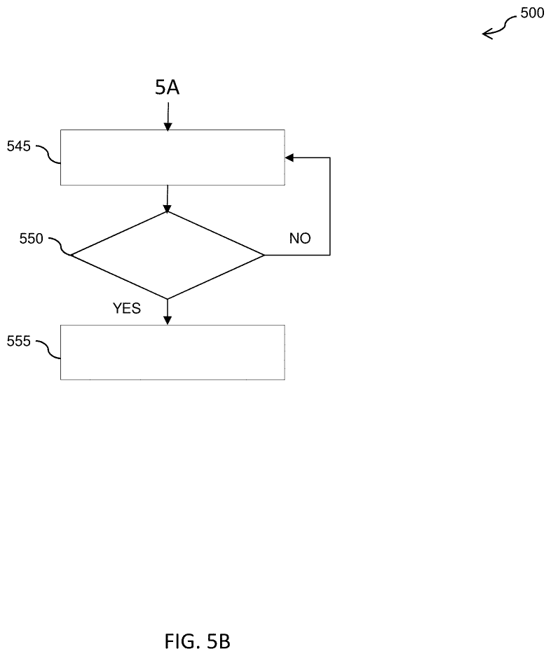

FIGS. 5A and 5B depict flow diagram of a method 500 for geo-location based transmission resource allocation for vehicle sensors according to one or more embodiments. At block 505, a server, for example server 54B, can determine transmission resources (i.e., frequency, time and code or combinations thereof) available for a given area. At block 510, the server 54B can partition the given area into a plurality of cells. The partitioning can be in consideration of predetermined distances which can allow for the reuse of transmission resources without causing interference between vehicles. At block 515, the server 54B can compare the available transmission resources to the number of cells in the partitioned area. Each cell in the partitioned area can be geo-located. At block 520, the server 54B can determine whether the number of cells in the partitioned area exceeds the available transmission resources.

If the number of cells in the partitioned area does not exceed the available transmission resources, the method 500 proceeds to block 540, where the server 54B can allocate a portion of the available transmission resources to each of the cells in the partitioned area. Method 500 would then proceed from block 540 to block 530.

If the number of cells in the partitioned area exceeds the available transmission resources, the method 500 proceeds to block 525, where the server 54B can allocate a portion of the available transmission resources to each of the cells in the partitioned area, as well as reuse the allocated transmission resources in cells which are beyond the predetermined distance. At block 530, the server 54B can locate each vehicle in the partitioned area. The server 54B can obtain GPS or other geo-location information from each vehicle.

At block 535, the server 54B can use the geo-location information for each cell in the partitioned area and GPS information for each vehicle in the partitioned to assign transmission resources allocated to a particular cell to each vehicle when the vehicle is located in the cell. At block 545, shown in FIG. 5B, the server 54B can monitor the partitioned area to determine the movement/location of each vehicle while traversing the partitioned area.

At block 550, the server 54B can determine when each vehicle has entered into another/new cell. If each vehicle has not entered a new cell, the method 500 returns to block 545. If a vehicle has entered a new cell, the method 500 proceeds to block 555 where the vehicle can be assigned the transmission resources allocated to the new cell.

Accordingly, the embodiments disclosed herein describe a system that can mitigate interferences between active sensors operated by different vehicles using a geo-location based transmission resource allocation for a plurality of cells within a designated area, such that vehicles that are in close proximity to each other will transmit with one set of transmission resources and vehicles beyond a distance which would cause low interference between vehicles will use similar transmission resources. The embodiments disclosed herein do not require synchronization or communication between the active sensors.

The system can partition a large geolocation area into cells each having a smaller geolocation area. The system can allocate to each cell a time-frequency resource such that neighbor cells will have different resource allocations. The system can also reuse the time-frequency resources in cells that are far in distance to a cell using the same time-frequency resources. Accordingly, active sensors using the same time and frequency resources will have minimal interference between cells using the same time-frequency resources since the interference is strongly attenuated with distance.

The system can also use a pre-determined set of global rules that relate each vehicle's geo-location to transmission resources allocated to the cell/location associated with the vehicle's geo-location without requiring maps or even a connection to a server. Each vehicle can determine its own geo-location (e.g. GPS), and determine transmission resources to be used based on the set of global rules. The global rules are defined such that vehicles at close geographical location (short distance) to each other will use different transmission resources than vehicles that are at a far geographical location (large distance) or can reuse the same transmission resources.

It is understood that although the embodiments are described as being implemented on a traditional processing system, the embodiments are capable of being implemented in conjunction with any other type of computing environment now known or later developed. For example, the present techniques can be implemented using cloud computing. Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. It should be appreciated that the computing environment 50 that is associated with a system for geo-location based transmission resource allocation for vehicle sensors can be implemented in a cloud computing environment, and cell length, width and geo-location information can be stored locally and/or remotely, such as in the cloud computing environment.

Technical effects and benefits of the disclosed embodiments include, but are not limited to reusing time, frequency, code and combinations thereof by taking into account interference attenuation in light of distance. Accordingly, a system can account of an increasing number of vehicles using active sensors by instructing vehicles to use transmission resources allocated to a particular cell and reusing allocated transmission resources when a distance between the current use of the allocated transmission resources and the new cell designated to use the currently allocated transmission resources is sufficient to cause negligible interference between the cell currently using the allocated transmission resources and the new cell designated to use the currently allocated transmission resources.

The present disclosure may be a system, a method, and/or a computer readable storage medium. The computer readable storage medium may include computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a mechanically encoded device and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method for geo-location based transmission resource allocation for vehicle sensors, the method comprising:
determining, by a processor, available transmission resources for an area;
partitioning, by the processor, the area into a plurality of cells;
determining, by the processor, whether the plurality of cells exceeds the available transmission resources;
allocating, by the processor, a portion of the available resources to a first set of one or more cells;
reusing, by the processor, the portion of the available resources allocated to the first set of one or more cells by allocating the portion of the available resources to a second set of one or more cells; and
assigning, by the processor, transmission resources associated with the second set of one or more cells to a second set of one or more vehicles when the second set of one or more vehicles enters an area associated with the second set of one or more cells.

2. The method of claim 1, further comprising assigning transmission resources associated with the first set of one or more cells to a first set of one or more vehicles.

3. The method of claim 2, wherein the assigned transmission resources are utilized by one or more active sensors associated with each of the first set of one or more vehicles and each of the second set of one or more vehicles.

4. The method of claim 1, wherein reusing the portion of the available resources allocated to the first set of one or more cells is based on a predetermined threshold distance between the first set of one or more cells and the second set of one or more cells.

5. The method of claim 1, further comprising using a pre-determined set of global rules to relate a geo-location for each vehicle of a first set of vehicles and the second set of vehicles to transmission resources allocated to the first set of one or more cells and second set of one or more cells.

6. The method of claim 1, wherein the available resources include at least one of: time, frequency and code.

7. The method of claim 1 further comprising monitoring movements associated with each of the first set of one or more vehicles and each of the second set of one or more vehicles and assigning transmission resources associated with a new cell when a vehicle enters into the new cell from a previous cell.

8. A system for geo-location based transmission resource allocation for vehicle sensors, the system comprising:
one or more vehicles; and
one or more servers, wherein each server comprises:
a memory; and
a processor coupled to the memory, wherein the processor is operable to:
determine available transmission resources for an area;
partition the area into a plurality of cells;
determine whether the plurality of cells exceeds the available transmission resources;
allocate a portion of the available resources to a first set of one or more cells;
reuse the portion of the available resources allocated to the first set of one or more cells by allocating the portion of the available resources to a second set of one or more cells; and
assign transmission resources associated with the second set of one or more cells to a second set of one or more vehicles when the second set of one or more vehicles enters an area associated with the second set of one or more cells.

9. The system of claim 8, wherein the processor is further operable to assign transmission resources associated with the first set of one or more cells to a first set of one or more vehicles.

10. The system of claim 9, wherein the assigned transmission resources are utilized by one or more active sensors associated with each of the first set of one or more vehicles and each of the second set of one or more vehicles.

11. The system of claim 8, wherein reusing the portion of the available resources allocated to the first set of one or more cells is based on a predetermined threshold distance between the first set of one or more cells and the second set of one or more cells.

12. The system of claim 8, wherein the processor is further operable to use a pre-determined set of global rules to relate a geo-location for each vehicle of a first set of vehicles and the second set of vehicles to transmission resources allocated to the first set of one or more cells and second set of one or more cells.

13. The system of claim 8, wherein the available resources include at least one of: time, frequency and code.

14. The system of claim 8, wherein the processor is further operable to monitor movements associated with each of the first set of one or more vehicles and each of the second set of one or more vehicles and assign transmission resources associated with a new cell when a vehicle enters into the new cell from a previous cell.

15. A non-transitory computer readable storage medium having program instructions embodied therewith, the program instructions readable by a processor to cause the processor to perform a method for geo-location based transmission resource allocation for vehicle sensors comprising:
determining available transmission resources for an area;
partitioning the area into a plurality of cells;
determining whether the plurality of cells exceeds the available transmission resources;
allocating a portion of the available resources to a first set of one or more cells;
reusing the portion of the available resources allocated to the first set of one or more cells by allocating the portion of the available resources to a second set of one or more cells; and
assigning transmission resources associated with the second set of one or more cells to a second set of one or more vehicles when the second set of one or more vehicles enters an area associated with the second set of one or more cells.

16. The computer readable storage medium of claim 15, further comprising assigning transmission resources associated with the first set of one or more cells to a first set of one or more vehicles.

17. The computer readable storage medium of claim 16, wherein the assigned transmission resources are utilized by one or more active sensors associated with each of the first set of one or more vehicles and each of the second set of one or more vehicles.

18. The computer readable storage medium of claim 15, wherein reusing the portion of the available resources allocated to the first set of one or more cells is based on a predetermined threshold distance between the first set of one or more cells and the second set of one or more cells.

19. The computer readable storage medium of claim 18, wherein the predetermined threshold distance is based on an interference strength calculation.

20. The computer readable storage medium of claim 15, further comprising monitoring movements associated with each of the first set of one or more vehicles and each of the second set of one or more vehicles and assigning transmission resources associated with a new cell when a vehicle enters into the new cell from a previous cell.
